(19) United States
(12) Patent Application Publication
(10) Pub. No.: US 2025/0242370 A1
(43) Pub. Date: Jul. 31, 2025

(54) APPARATUS AND METHODS FOR MARKING A GROUND SURFACE

(71) Applicant: Micropply Limited, Altrincham, Cheshire (GB)

(72) Inventors: Anthony David George Rhoades, Hale, Altrincham (GB); Samuel Paul Cornish-Evans, Knutsford, Cheshire (GB); Lewis Cassidy, Stretford, Manchester (GB)

(21) Appl. No.: 18/853,174

(22) PCT Filed: Apr. 12, 2023
(86) PCT No.: PCT/GB2023/050987

§ 371 Date: Oct. 1, 2024

(30) Foreign Application Priority Data
Apr. 12, 2022 (GB) 2205452.2

(51) Int. Cl. B05B 13/00; A63C 19/06; B05B 12/04; B05B 13/04; B05D 1/02

(52) U.S. Cl. CPC B05B 13/005; A63C 19/065; B05B 12/04; B05B 13/041; B05D 1/02; A63C 2019/067

(57) ABSTRACT

A ground printer for marking a ground surface, the ground printer comprising a print rack and being configured to travel in a first direction over the ground surface, the print rack comprising: a horizontal mounting rail positionally fixed to the ground printer and arranged in a second direction, substantially orthogonal to the first direction; and a vertical mounting rail arranged in a third direction, substantially orthogonal to the first direction and substantially orthogonal to the second direction, the vertical mounting rail being movably connected to the horizontal mounting rail; wherein a plurality of spray nozzles is mounted to the vertical mounting rail and aligned in a horizontal axis in the first direction.

### TECHNICAL FIELD

The present disclosure relates to apparatus and methods for marking a ground surface. In particular, but not exclusively, it relates to an autonomous ground printer having a print rack arrangement with adjustable print nozzles for marking a ground surface with paint or ink.

Aspects of the invention relate to a ground printer for marking a ground surface and a method of marking a ground surface.

### BACKGROUND

Ground marking has traditionally been carried out using manual processes. Ground marking may be carried out using manual line marking equipment, for example to mark out sports pitches, or by using a manual image painting process using stencils and paint which may be painted or sprayed into the cutouts in the stencils, for example to mark areas of ground with a sponsor logo. Such logos may be required to be large enough to see from a long distance, in some cases by aerial photography of all or parts of a sports pitch or venue, and such manual marking can therefore take considerable time to complete, especially if the image to be painted is complex or is a multi-colour image. Further, such a manual process can be a complex task requiring significant user skill to complete. In addition, manual painting of a ground surface can often only provide satisfactory visible results when the ground surface is saturated in paint such that the intensity of an image is consistent at different parts of the image. Such saturation of the ground surface with paint firstly consumes considerable paint at considerable cost, secondly causes difficulty in removing the paint once the image is no longer required to be present on the ground surface, and thirdly has a more detrimental effect on the environment.

Autonomous ground printers, also known as autonomous ground marking robots, are becoming more commonplace for line marking of sports pitches and for image printing of logos. Such ground printers can autonomously move on a predetermined path and deposit paint in a predetermined pattern to mark lines or print pixels on a ground surface. In particular, paint or ink can be deposited by a single print nozzle to form a line or a pixel of an image, or from multiple print nozzles to form multiple pixels of an image. However, such printing can still be slow when an image requires multiple colours of paint or ink to be deposited, and the image intensity can vary dependent on the ground surface.

It is an aim of the present invention to address at least some of the disadvantages associated with the prior art.

### SUMMARY OF THE INVENTION

Aspects and embodiments of the invention provide a ground printer for marking a ground surface and a method of marking a ground surface, as claimed in the appended claims.

According to an aspect of the invention there is provided a ground printer for marking a ground surface, the ground printer comprising a print rack and being configured to travel in a first direction over the ground surface, the print rack comprising: a horizontal mounting rail positionally fixed to the ground printer and arranged in a second direction, substantially orthogonal to the first direction; and a vertical mounting rail arranged in a third direction, substantially orthogonal to the first direction and substantially orthogonal to the second direction, the vertical mounting rail being movably connected to the horizontal mounting rail; wherein a plurality of spray nozzles is mounted to the vertical mounting rail and aligned in a horizontal axis in the first direction.

An advantage of this invention is that multi-directional printing can be put into effect bringing significant speed improvements over a print rack with fixed spray nozzles and the height of the spray nozzles can be dynamically adjusted to account for the requirements of different images to be printed and different surfaces to be printed upon.

The vertical mounting rail may be configured to move along the horizontal mounting rail between a first end stop at a first end of the horizontal mounting rail and a second end stop at a second end of the horizontal mounting rail opposite the first end of the horizontal mounting rail.

The first end stop and the second end stop may be separated by a distance which is greater than the separation of the wheels of the ground printer. This provides the advantage of allowing tiling of printed images without the ground printer being required to be positioned such that the wheels of the ground printer pass over a previously printed part of the image.

One, or both, of the first end stop and the second end stop may comprise a sensor to detect the position of the vertical mounting rail.

The vertical mounting rail may be configured to move orthogonally to the horizontal mounting rail in the third direction.

The horizontal mounting rail may comprise a first stepper motor with a first pulley at the first end of the horizontal mounting rail, and a second pulley at the second end of the horizontal mounting rail, the first pulley being operably coupled to the second pulley via a first belt, and a carriage being coupled to the first belt, the carriage being configured to traverse the horizontal mounting rail on operation of the first stepper motor.

The first stepper motor may comprise a closed loop encoder.

The vertical mounting rail may comprise a second stepper motor with a third pulley at a first end of the vertical mounting rail, and a fourth pulley at a second end of the vertical mounting rail opposite the first end of the vertical mounting rail, the third pulley being operably coupled to the fourth pulley via a second belt, and the carriage being coupled to the second belt to enable the vertical mounting rail to move in the third direction, orthogonally to the horizontal mounting rail on operation of the second stepper motor.

The second stepper motor may comprise a closed loop encoder.

The second stepper motor may be configured to provide greater torque output than the first stepper motor. An advantage of this feature is that the second stepper motor can provide sufficient torque output to overcome any additional force arising from the effects of gravity when raising the spray nozzles in the third direction.

The carriage may comprise: four wheels on a first side of the carriage, the four wheels on the first side of the carriage comprising two wheels configured to engage a first side of a track portion of the horizontal mounting rail and two wheels configured to engage with a second side of the track portion of the horizontal mounting rail opposite the first side of the track portion of the horizontal mounting rail; and four wheels on a second side of the carriage opposite the first side of the carriage, the four wheels on the second side of the carriage comprising two wheels configured to engage a first side of a track portion of the vertical mounting rail and two wheels configured to engage with a second side of the track portion of the vertical mounting rail opposite the first side of the track portion of the vertical mounting rail.

Two of the four wheels on the first side of the carriage may be provided with eccentric nuts to enable movement of the two wheels on the first side of the carriage relative to the other two of the wheels of the first side of the carriage during tightening to the eccentric nuts in order to clamp the four wheels of the first side of the carriage onto the track portion of the horizontal mounting rail. Two of the four wheels on the second side of the carriage may be provided with eccentric nuts to enable movement of the two wheels on the second side of the carriage relative to the other two wheels of the second side of the carriage during tightening of the eccentric nuts in order to clamp the four wheels of the second side of the carriage onto the track portion of the vertical mounting rail. An advantage of this feature is that when tightened, the eccentric nuts lead to a tightening of the wheels onto the track portion of the horizontal mounting rail and a tightening of the wheels onto the track portion of the vertical mounting rail to allow the wheels to roll in a track on the respective mounting rail such that the carriage is securely affixed to both the horizontal mounting rail and the vertical mounting rail.

The plurality of spray nozzles may be configured to move in the third direction to modify the separation of the spray nozzles from the ground surface. An advantage of this feature is that by adjusting the height of the spray nozzles above the ground by movement of the spray nozzles in the third direction, the size of the pixels sprayed by the spray nozzles can be adjusted, such that when less resolution is required for an image the pixel size can be increased leading to an increase in printing speed.

Each spray nozzle of the plurality of spray nozzles may be coupled to a separate respective paint cartridge.

Each spray nozzle may be coupled to the separate respective paint cartridge via flexible tubing to accommodate movement of the spray nozzles relative to the respective paint cartridges.

The flexible tubing may be retained in a first cable carrier mounted to the vertical mounting rail and a second cable carrier mounted to the horizontal mounting rail, the flexible tubing passing from a respective print spray nozzle, through the first cable carrier and then through the second cable carrier, to the respective paint cartridge. An advantage of this feature is that the tubing is less prone to becoming entangled or caught on any other component of the ground printer during the movement of the print spray nozzles in the second direction or the third direction.

The paint may be ejected from each spray nozzle under pressure to form small droplets of paint to uniformly cover the ground surface. An advantage of this feature is that more consistent paint coverage of a ground surface can be obtained with less paint, as less saturation of the ground surface is required. For example, on a ground surface such as grass, the pressurised paint spraying allows consistent coverage of the ground surface whilst only painting the top of the blades of grass. This provides the further advantage of minimising the amount of paint used to paint lines and images on the ground surface meaning that less paint enters the ground surface or washes off into water courses, thereby providing an environmental benefit over prior painting methods.

The ground printer may comprise: a controller configured to control the position of the ground printer on a ground surface, to control the position of the plurality of spray nozzles on the ground printer, and to control the operation of the plurality of spray nozzles to mark the ground surface.

The controller may be configured to control a valve for each of the plurality of spray nozzles dependent upon the position of the ground printer on the ground surface.

According to an aspect of the invention there is provided a method of marking a ground surface using a ground printer as described in any preceding aspect, the method comprising: moving the ground printer in the first direction over the ground surface; and moving the plurality of spray nozzles on the ground printer in the second direction, substantially orthogonal to the first direction.

The method may comprise: moving the plurality of spray nozzles on the ground printer in the third direction, substantially orthogonal to the first direction and substantially orthogonal to the second direction.

The method may comprise: controlling a plurality of valves, each valve being connected between a respective paint cartridge and a respective spray nozzle, to deposit paint on the ground surface below the respective spray nozzle.

The method may comprise: for each of the paint cartridges, monitoring a parameter relating to a volume of paint in the respective paint cartridge; and stopping the ground printer when one of the parameters relating to the volume of paint in the paint cartridges reduces below a predetermined level.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIGS. 1a, 1b & 1c are a side elevation and plan views of a ground printer, according to an embodiment of the invention;

FIG. 2 illustrates a perspective view of a print rack for a ground printer for marking a ground surface according to an embodiment of the invention;

FIG. 3 illustrates a perspective view of a mounting rail according to an embodiment of the invention;

FIG. 4 illustrates a perspective view of a carriage for a print rack, according to an embodiment of the invention;

FIG. 5 illustrates a perspective view of a ground printer for marking a ground surface with a detached cover, according to an embodiment of the invention; and

FIG. 6 is a flow diagram of the method of marking a ground surface according to an embodiment of the invention.

In the drawings, like parts are denoted by like reference numerals.

### DETAILED DESCRIPTION

Examples of the present disclosure relate to an apparatus for marking a ground surface. In particular, examples of the present disclosure relate to an apparatus for marking a ground surface having spray nozzles for ejecting paint or ink, under pressure, onto a ground surface. Non-limiting examples will now be described with reference to the accompanying drawings.

The figures illustrate an apparatus for marking a ground surface 100, in the form of a ground printer 10 or ground marking robot. The ground printer 10 is intended for printing line markings and/or complex images on a ground surface 100 without user intervention following an initial setup of the ground printer 10.

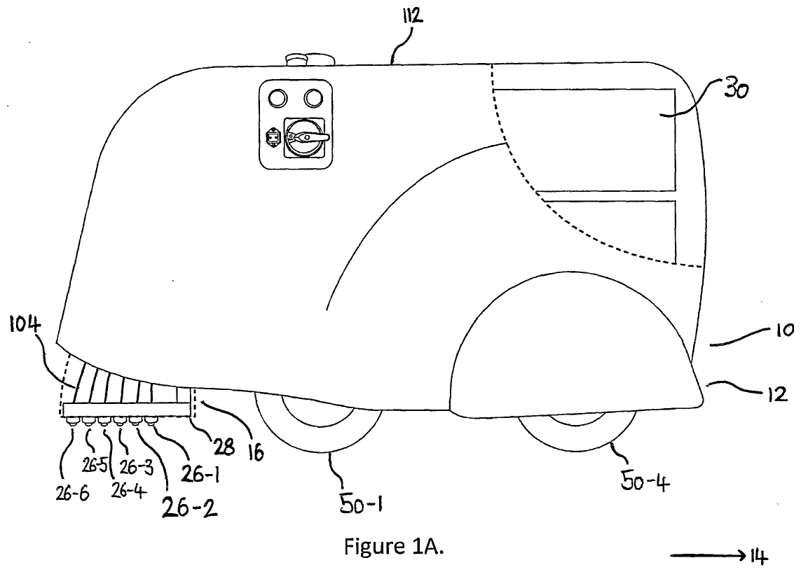

FIG. 1A, 1B & 1C

FIG. 1A is a side elevation of a ground marking robot, FIGS. 1B and 1C are plan views of the ground printer 10, wherein 1B is a top view, 1C is an underneath view. The ground printer 10 is configured to travel in a first direction 14 over the ground surface 100.

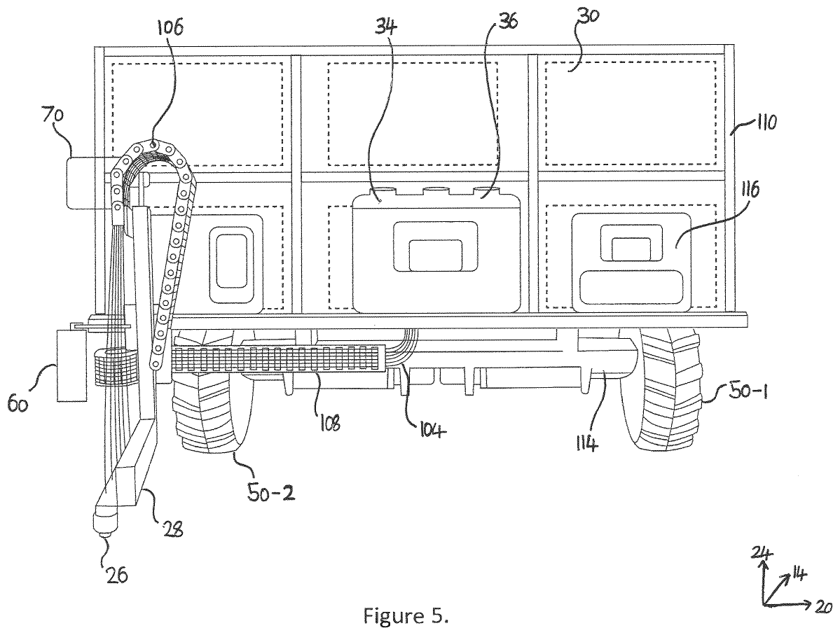

The ground printer 10 further comprises a case or cover 12 held securely by a chassis (shown in FIG. 5) supporting a ground wheel arrangement 50 (1-4) with a print head 28 on a traverse guide 18 in the form of a horizontal mounting rail 18, the horizontal mounting rail 18 permitting movement of the print head 28 beyond the width W of the ground wheel arrangement 50 (1-4), along the length of the print width 68. A spray nozzle array formed of spray nozzles 26 as described below may be attached to the print head 28. The spray nozzles 26 may be fixed and the print head 28 moveable. The print head 28, via the horizontal mounting rail 18, may be moveable along the length of a print width 68, which is the area the print head 28 is capable of printing. The print head 28 many also be movable vertically based on the image to be printed, for example the print head 28 can be moved up and down depending on the density of the image to be printed. The print head 28 can have a means (not shown) to monitor the ground height and adjust the height of the print head 28 accordingly, allowing for more accurate image printing or material deposition.

The ground wheel arrangement 50 comprises wheels 50-1, 50-2, 50-3 and 50-4 to steer the ground printer 10 along a path to effect the printing, and this may be under the control of a print file that can be loaded into an on-board control system such as may be contained in a communications module (as described with further reference to FIG. 5). The horizontal mounting rail 18 is fixed in relation to the ground wheel arrangement 50, so that it prints one line of an image along the print width 68.

The print head 28 can be height adjustable, whereby to print finer or coarser images or to adapt to ground irregularities. The print head 60 can use any of a variety of printing techniques, including standard ink jet, spray, and 3D printing techniques involving melting plastic and dropping or shooting it at a ground surface.

Further ground printer 10 components are illustrated in FIG. 5 where the cover 12 is not shown.

In the remainder of the description of the embodiments of the invention, the ground marking substance is described as being paint, which may be a latex acrylic paint, though it will be understood that any suitable ground marking substance can be used.

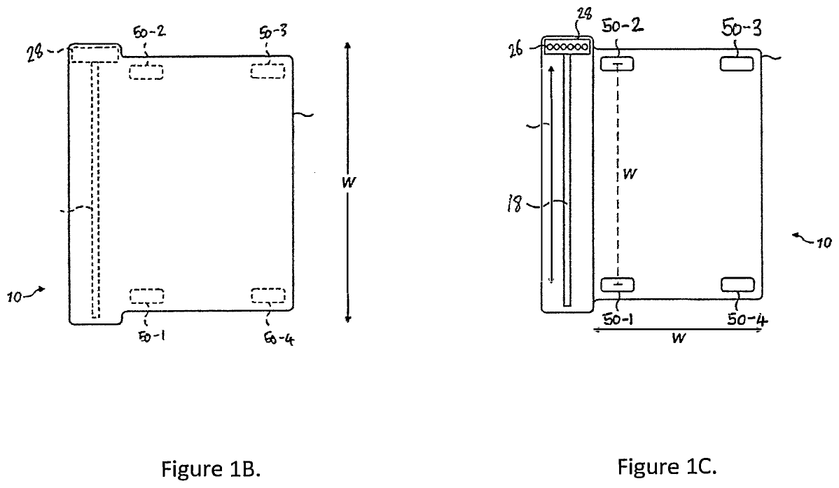

In the embodiments shown in FIG. 1A, FIG. 1C, FIG. 2, and FIG. 5, the print rack 16 comprises a spray nozzle array with six spray nozzles 26-1, 26-2, 26-3, 26-4, 26-5, 26-6, though it will be understood that more or less spray nozzles 26 may be provided on the print rack 16, to be moved in a first direction 14 by the ground printer 10. Thus, when the ground printer has six separate spray nozzles 26 the ground printer 10 can deposit six different colours of paint or less colours with greater volume of paint. Each of the six spray nozzles 26 can be operated independently of the other spray nozzles 26, meaning that at any one time any or all of the spray nozzles 26 may be operational to deposit paint on the ground surface 100.

FIG. 2

As illustrated in FIG. 2, a vertical mounting rail 22 can move along the horizontal mounting rail 18, whilst maintaining its vertical orientation, between a first end stop 40 at a first end 42 of the horizontal mounting rail 18 and a second end stop 44 at a second end 46 of the horizontal mounting rail 18, the second end 46 being an opposite end of the horizontal mounting rail 18 to the first end 42.

Printing from the spray nozzles 26 can be carried out as the vertical mounting rail 22 moves from the first end 42 of the horizontal mounting rail 18 to the second end 46 of the horizontal mounting rail 18, and can also be carried out as the vertical mounting rail 22 moves from the second end 46 of the horizontal mounting rail 18 to the first end 42 of the horizontal mounting rail 18, thereby providing multi-directional printing.

As illustrated in FIG. 2, the first end stop 42 and the second end stop 46 are separated by a distance which is greater than the separation of the wheels of the ground printer 10, that is greater than the wheel track of the ground printer 10. The horizontal mounting rail 18 thereby permits movement of the spray nozzles 26, along its length, beyond the width of the wheel track of the ground printer 10. The spray nozzles 26 are positionally fixed relative to each other such that there is a known separation between each spray nozzle 26, the plurality of spray nozzles 26 being located on the print head 28, where the print head 28 is moveable relative to the horizontal mounting rail 18. The print head 28, via the horizontal mounting rail 18, may be moveable along the length of a print width, which is the area the print head 28 is capable of printing.

The print head 28 many also be movable vertically based on the image to be printed, for example the print head 28 can be moved up and down depending on the density of the image to be printed. The print head 28 can have a means, such as a sensor, (not shown) to monitor the ground height and adjust the height of the print head 28 accordingly above the ground surface 100, allowing for more accurate image printing or material deposition.

In order to move the spray nozzles 26 to print an image, the horizontal mounting rail 18 may comprise a first stepper motor 60 with a first pulley 62 at the first end 42 of the horizontal mounting rail 18, and a second pulley 64 at the second end 46 of the horizontal mounting rail 18, the second end 46 being an end of the horizontal mounting rail 18 opposite to the first end 42.

The first pulley 62 is operably coupled to the second pulley 64 via a first belt 66. A carriage 68 is coupled to the first belt 66. In particular, the first belt 66 passes through apertures in the carriage 68 and is fixed thereto, for example by clamping the first belt 66 to the carriage 68. The carriage 68 is configured to traverse the horizontal mounting rail 18 on operation of the first stepper motor 60. In some embodiments, the first belt 66 is a toothed belt, and the first pulley 62 is a toothed pulley with teeth to engage corresponding teeth of the toothed belt 66. In some embodiments the second pulley 64 is also a toothed pulley with teeth to engage corresponding teeth of the toothed first belt 66. The second pulley 64 may be adjusted in an axis along the lengthwise axis of the horizontal mounting rail 18 to tension the first belt 66.

The first stepper motor 60 may comprise a closed loop encoder to account for any lost steps of the first stepper motor 60, by, for example, the application of step-loss compensation or load position control. In the first stepper motor 60 each pulse of current applied to the stepper motor may equate to a single motor step. In some embodiments, micro-stepping control can be applied to the first stepper motor 60 which divides each full step into a number of smaller steps, such as two hundred and fifty six smaller steps. By providing micro-stepping control, fine movements of the print head 28 can be provided ensuring accurate printing of the image. For example by providing micro-stepping control pixels may be placed within an accuracy of 1 to 3 mm of the final intended image.

The vertical mounting rail 22 may comprise a second stepper motor 70 with a third pulley 72 at a first end 74 of the vertical mounting rail 22, and a fourth pulley 76 at a second end 78 of the vertical mounting rail 22 opposite the first end 74 of the vertical mounting rail 18.

The third pulley 72 is operably coupled to the fourth pulley 76 via a second belt 80. The carriage 68 is coupled to the second belt 80, via apertures in the carriage 68, for example by clamping the second belt 80 to the carriage 68. By coupling the carriage 68 to the second belt 80 the vertical mounting rail 22 is enabled to move in the third direction 24, orthogonally to the horizontal mounting rail 18 on operation of the second stepper motor 70. In some embodiments, the second belt 70 is a toothed belt, and the third pulley 72 is a toothed pulley with teeth to engage corresponding teeth of the toothed belt 70. In some embodiments the fourth pulley 76 is also a toothed pulley with teeth to engage corresponding teeth of the toothed second belt 70. The fourth pulley 76 may be adjusted in an axis along a lengthwise axis of the vertical mounting rail 22 to tension the second belt 80.

Since the horizontal mounting rail 18 is fixedly positioned on the ground printer 10, when the second stepper motor 70 is operated, the vertical mounting rail 22 moves in the third direction 24, relative to the horizontal mounting rail 18, thereby effecting movement of the spray nozzles 26 in the third direction 24. Moving the spray nozzles 26 in the third direction 24 moves the spray nozzles 26 closer to, or further away from, the ground surface 100 onto which paint is to be deposited from the spray nozzles 26, for example in the form of a line or pixel of an image. When the spray nozzles 26 are further away from the ground surface 100 a larger area of ground surface 100 will be covered by the paint ejected from the spray nozzles and therefore printing of an image can be effected quicker.

The second stepper motor 70 may comprise a closed loop encoder to account for any lost steps of the second stepper motor 70, by, for example, the application of step-loss compensation or load position control. In the second stepper motor 70 each pulse of current applied to the stepper motor may equate to a single motor step. In some embodiments micro-stepping control can be applied to the second stepper motor 70 which divides each full step into a number of smaller steps, such as two hundred and fifty six smaller steps.

The second stepper motor 70 may be configured to provide greater torque output than the first stepper motor 60, in order to additionally overcome gravitational force acting on the vertical mounting rail 22 and print head 28 of the print rack 16 when the spray nozzles 26 are raised to increase the distance between the spray nozzles 26 and the ground surface 100 in the third direction 24. Alternatively, it can be considered that the first stepper motor 60 may be a smaller motor providing less torque output than the second stepper motor 70 and which may be more energy efficient than the larger second stepper motor 70.

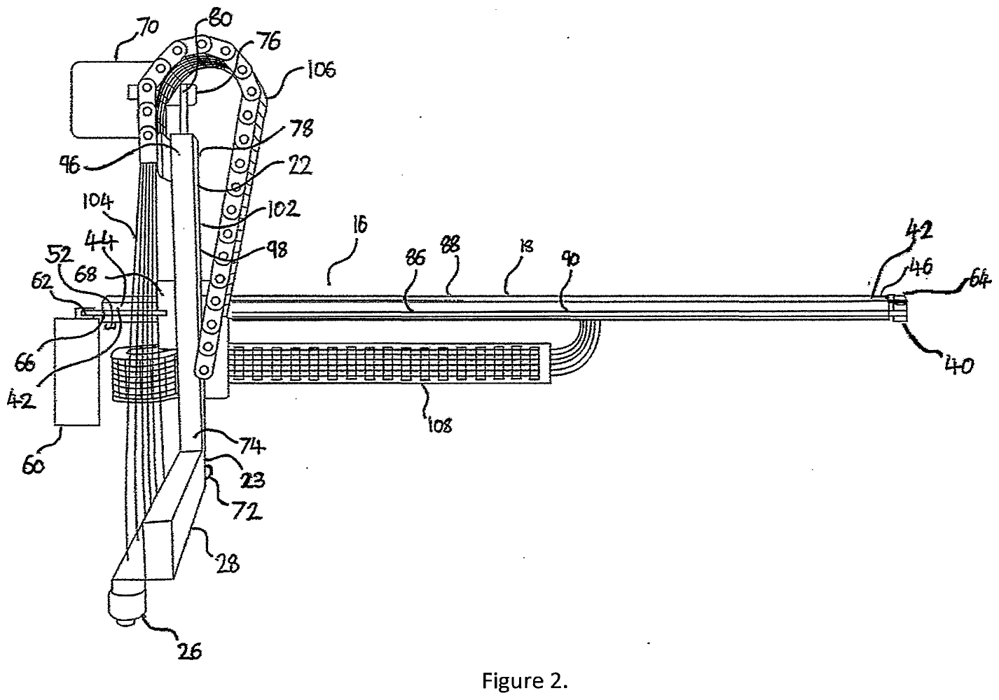

FIG. 3

FIG. 3 illustrates, in more detail, a section of a v-slot extrusion which may be used for the horizontal mounting rail 18, noting that the vertical mounting rail 22 may be formed of the same v-slot extrusion material to provide the same functionality. The track portion 90 of the horizontal mounting rail 18 may comprise such a v-slot extrusion within which wheels 82-1, 82-2, 82-3, 82-4 of a carriage 68 engage to allow the carriage 68 to traverse along the length of the horizontal mounting rail 18. Similarly, the track portion 102 of the vertical mounting rail 22 comprises a v-slot extrusion within which wheels 92-1, 92-2, 92-3, 92-4 of the carriage 68 engage to allow the carriage 68 to traverse along the length of the vertical mounting rail 22.

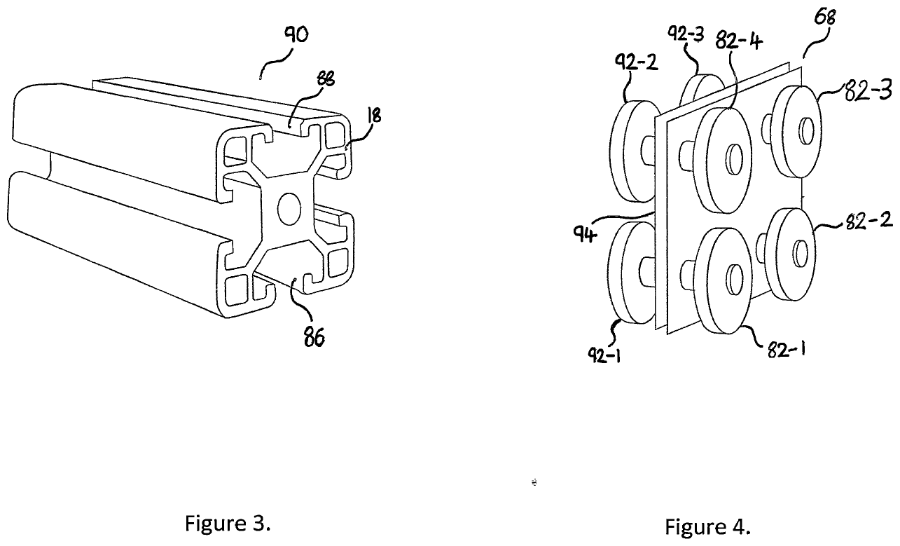

FIG. 4

FIG. 4 illustrates the carriage 68 by which the spray nozzles 26 are moved in a widthwise direction 20 relative to the ground printer 10 and a vertical direction 24 relative to the ground printer 10.

As illustrated in FIG. 4, the carriage 68 may comprise: four wheels 82-1, 82-2, 82-3, 82-4 on a first side 84 of the carriage 68, the four wheels 82-1, 82-2, 82-3, 82-4 on the first side 84 of the carriage 68 comprising two wheels 82-1, 82-2 configured to engage a first side 84 of a track portion 90 of the horizontal mounting rail 18 and two wheels 82-3, 82-4 configured to engage with a second side 88 of the track portion 90 of the horizontal mounting rail 18 opposite the first side 86 of the track portion 90 of the horizontal mounting rail 18.

Two wheels 82-1, 82-4 of the four wheels 82-1, 82-2, 82-3, 82-4 on a first side 84 of the carriage 68 may be provided with eccentric nuts to enable movement of the two wheels 82-1, 82-4 on the first side 84 of the carriage 68 relative to the other two wheels 82-2, 82-3 of the four wheels 82-1, 82-2, 82-3, 82-4 on the first side 84 of the carriage 68 during tightening of the eccentric nuts in order to clamp the four wheels 82-1, 82-2, 82-3, 82-4 of the first side 84 of the carriage 68 onto the track portion 90 of the horizontal mounting rail 18.

On the first side 84 of the carriage 68, the wheels 82-1, 82-4 which are provided with eccentric nuts comprise a first wheel 82-1 which is configured to engage with the first side 86 of the track portion 90 of the horizontal mounting rail 18, and a second wheel 82-4 which is configured to engage with the second side 88 of the track portion 90 of the horizontal mounting rail 18 opposite the first side 86 of the track portion 90 of the horizontal mounting rail 18.

Two wheels 92-2, 92-3 of the four wheels 92-1, 92-2, 92-3, 92-4 on the second side 94 of the carriage 68 may be provided with eccentric nuts to enable movement of the two wheels 92-2, 92-3 on the second side 94 of the carriage relative to the other two wheels of the second side of the carriage during tightening of the eccentric nuts in order to clamp the four wheels 92-1, 92-2, 92-3, 92-4 of the second side 94 of the carriage 68 onto the track portion 102 of the vertical mounting rail 22.

On the second side 94 of the carriage 68, the wheels 92-2, 92-3 which are provided with eccentric nuts comprise a first wheel 92-2 which is configured to engage with the first side 96 of the track portion 102 of the vertical mounting rail 22, and a second wheel 92-3 which is configured to engage with the second side 98 of the track portion 102 of the vertical mounting rail 22 opposite the first side 96 of the track portion 102 of the vertical mounting rail 22.

The use of eccentric nuts facilitates tightening of the wheels 82-1, 82-2, 82-3, 82-4 onto the track portion 90 of the horizontal mounting rail 18 and a tightening of the wheels 92-1, 92-2, 92-3, 92-4 onto the track portion 102 of the vertical mounting rail 22 to allow the wheels 82-1, 82-2, 82-3, 82-4, 92-1, 92-2, 92-3, 92-4 to move or roll in a track 90, 102 on the respective mounting rail 18, 22 such that the carriage 68 is securely affixed to both the horizontal mounting rail 18 and the vertical mounting rail 22.

FIG. 5

As illustrated in FIG. 5, the paint is retained onboard the ground printer 10 in a series of print cartridges 30, which, when filled with paint may be called paint cartridges 30, for example in six separate paint cartridges 30 inserted into the front of the ground printer 10. Each spray nozzle 26-1, 26-2, 26-3, 26-4, 26-5, 26-6 of the plurality of spray nozzles 26 may be coupled to a separate respective paint cartridge 30. The paint may be ejected from each spray nozzle 26 under pressure to form small droplets of paint to uniformly cover the ground surface 100.

Each of the paint cartridges 30 forms part of a pressurised airless spray system and is connected to a respective spray nozzle arrangement via an airtight valve outlet (not shown) of the paint cartridge 30. A pump, such as a self-priming diaphragm pump, may be used to pressurise the spray system for each respective spray nozzle 26. The pumps may be individually controlled by the controller 30 and the pressure for each pump may be adjusted depending on the paint being used for the respective spray nozzle 26. Different paints may be of different viscosities, therefore requiring different pressure to be applied to the spray system for each spray nozzle 26.

This spray system may beneficially reduce or prevent dripping of paint from the spray nozzles 26, by providing back pressure at the spray nozzles 26. Such an arrangement differs from agricultural spray systems, which use less viscous fluids than the present invention and use breather nozzles to help with back pressure, which can lead to dripping of fluids onto the ground surface 100. However, in agricultural spray systems, dripping of the fluids onto the ground surface 100 is generally not a problem. The higher viscosity fluids, such as paint, used in the present invention don't provide the same back pressure problem, and this coupled with the pressurization of the spray system minimises dripping of paint onto the ground surface 100.

The spray nozzle arrangement comprises flexible tubing 104, or hoses, to convey paint from the paint cartridge 30 to a respective spray nozzle 26, a valve (not shown), such as a solenoid valve, between the paint cartridge 30 and the spray nozzle 26, and a spray nozzle 26. Each spray nozzle 26 may be coupled to the separate respective paint cartridge 30 via the flexible tubing 104 to accommodate movement of the spray nozzles 26 relative to the respective paint cartridges 30. The valve (not shown) is controlled by an onboard controller 36, or print control module, to be open when printing of the ground surface 100 is required and closed when printing is not required. Paint is ejected from the spray nozzles 26 under pressure, which may be up to a maximum of 10 bar (1000 kPa) hydraulic pressure per spray nozzle 26. In some embodiments the paint is ejected from the spray nozzles 26 at a pressure of 7 bar (700 kPa).

The ground printer 10 has a horizontal mounting rail 18 positionally fixed to the ground frame 112 of the ground printer 10. The horizontal mounting rail 18 is a linear guide formed of an extruded material providing extruded channels. The horizontal mounting rail 18 is arranged in a second direction 20, substantially orthogonal to the first direction 14. That is, the horizontal mounting rail 18 is in an axis across the ground printer 10, orthogonal to an axis defining the direction of travel of the ground printer 10.

The ground printer 10 has a vertical mounting rail 22 arranged in a third direction 24, substantially orthogonal to the first direction 14 and substantially orthogonal to the second direction 20, the vertical mounting rail 22 being movably connected to the horizontal mounting rail 18. The vertical mounting rail 22 is a linear guide formed of an extruded material providing extruded channels.

A plurality of spray nozzles 26 is mounted to a lower portion 23 of the vertical mounting rail 22, such that the plurality of spray nozzles 26 may be configured to move in the third direction 24 to modify the separation of the spray nozzles 26 from the ground surface 100. In particular the spray nozzles 26 are mounted on a print head 28, which may be, in some embodiments, formed from a length of extruded rail with a plate through which the spray nozzles 26 project.

The print head 28 is fixed to the lower portion 23 of the vertical mounting rail 22. The plurality of spray nozzles 26 are aligned in a horizontal axis in the first direction 14, that is, orthogonal to the horizontal mounting rail 18. The spray nozzles 26 are configured to spray paint onto the ground surface 100 such that a desired marking, or a desired image, is printed onto the ground surface 100 as the ground printer 10 follows instructions to carry out a printing task which may be received from a user of the ground printer 10.

The horizontal mounting rail 18 is fixed in relation to the ground printer 10, so that the ground printer 10 can print pixels, in lines, of an image along the print width with the print head 28 moving from the first end 42 of the horizontal mounting rail 18 to the second end 46 of the horizontal mounting rail 18. In the embodiment where six spray nozzles 26 are arranged in the first direction 14, six lines of pixels of an image can be printed in one pass of the print head 28, each line depositing paint of a particular colour for the respective pixels.

The ground printer 10 then moves forward, in order for further pixels of the image to be printed when the print head 28 moves back to the first end 42 of the horizontal mounting rail 18 from the second end 46 of the horizontal mounting rail 18. Once the ground printer 10 has moved forwards, this has the effect of shifting the printing of the different coloured pixels by one line. The print head 28 can, for example, print pixels in six lines of 10 mm width, then the ground printer 10 may move forward by 10 mm before the next six lines are printed, the next six lines overlapping with five of the previous lines. The distance that the print head 28 is above the ground surface 100 dictates, at least in part, the size of the pixels and therefore the movement of the ground printer 10 between print passes of the print head 28 across the horizontal mounting rail 18.

The arrangement of the horizontal mounting rail 18 permitting movement of the spray nozzles 26, along its length, beyond the width of the wheel track of the ground printer 10, thereby facilitates tiling of printed images without the ground printer 10 being required to be positioned such that the wheels 50-1, 50-2, of the ground printer 10 pass over a previously printed part of the image. The ground printer 10 can print a strip of an image wider than the separation of the wheels of the ground printer 10, that is greater than the wheel track of the ground printer 10. When a strip of the image has been printed, the ground printer 10 can turn around to print an adjacent strip. In this way, the wheels 50-1, 50-2, of the ground printer 10 do not run over any part of the freshly painted ground.

One, or both, of the first end stop 42 and the second end stop 46 may comprise a sensor 52 to detect the position of the print head 28 and/or vertical mounting rail 22. The, or each, sensor 52 may be a switch, such as a limit switch, arranged or configured to act as an end stop and to indicate when the print head 28 and/or vertical mounting rail 22 is positioned at an outer extremity of the printing range of the ground printer 10. The sensor 52 or sensors can provide information to the controller 30 indicating the position of the print head 28, such that the controller 30 can be sure as to the absolute print head 28 position at that time. The sensor 52 may provide a home signal to the controller 30 to calibrate the position of the print head 28, such that, at any time during a printing process, the controller 30 may control the print head to move to the end stop to activate the sensor 52 and reset position information retained for the print head 28 held by the controller 34. In this way, the accuracy of printing can be maintained over a whole print task.

The vertical mounting rail 22 may be configured to move orthogonally to the horizontal mounting rail 18 in the third direction 24, that is up and down relative to the ground surface 100. Therefore, the height of the spray nozzles 26 which are attached to the vertical mounting rail 22, above the ground surface 100, can be dynamically adjusted to account for the requirements of different images to be printed and/or different surfaces to be printed upon.

For example, the vertical mounting rail 22 may be raised when printing on grass or when printing an image which is to have a lower resolution, that is a larger pixel size, and the vertical mounting rail 22 may be lowered when printing on asphalt or when printing an image which is to have a higher resolution, that is a smaller pixel size.

In some embodiments the flexible tubing 104 used to transfer or convey paint from a paint cartridge 30 to a spray nozzle 26 may have a small inner diameter, for example 2.5 mm diameter, with a relatively thin sidewall. Such a flexible tubing 104 size allows substantially unimpeded movement of the spray nozzles 26 in the second direction 20 and the third direction 24, such that is there is less torque required by the stepper motors 60, 70 to move the spray nozzles 26. Various materials may be used to form the flexible tubing 104 where some materials may be one of polyurethane, polyvinyl chloride, polypropylene, fluoropolymer, rubber, silicone or other similar materials.

The flexible tubing 104 may be retained in a first cable chain, echain, or cable carrier, functioning as a first tubing carrier 106, mounted to the vertical mounting rail 22, as illustrated in FIG. 2 and FIG. 5, and a second cable chain, echain, or cable carrier, functioning as a second tubing carrier 108 mounted to the horizontal mounting rail 18, as illustrated in FIG. 2 and FIG. 5. The flexible tubing 104 passes or is routed from a respective spray nozzle 26, through the first tubing carrier 106 and then through the second tubing carrier 108, to the respective paint cartridge 30. By routing the flexible tubing through the first tubing carrier 106 and the second tubing carrier 108, the tubing is less prone to becoming entangled or caught on any other component of the ground printer 10 during the movement of the spray nozzles 26 in the second direction 20 or the third direction 24.

The controller 30 may be configured to control a valve (not shown), such as a solenoid valve, for each of the plurality of spray nozzles 26 dependent upon the position of the ground printer on the ground surface 100.

The ground printer 10 can communicate with a remote server, through any wired or wireless network. For example, the ground printer 10 may comprise communication circuitry (not shown) for communicating with a remote server via a cellular network. A user can initiate the printing of a print task, such as the printing of markings or printing of an image, by selecting a printing task on a connected user device which then provides instructions for the printer to follow in order to carry out the printing task.

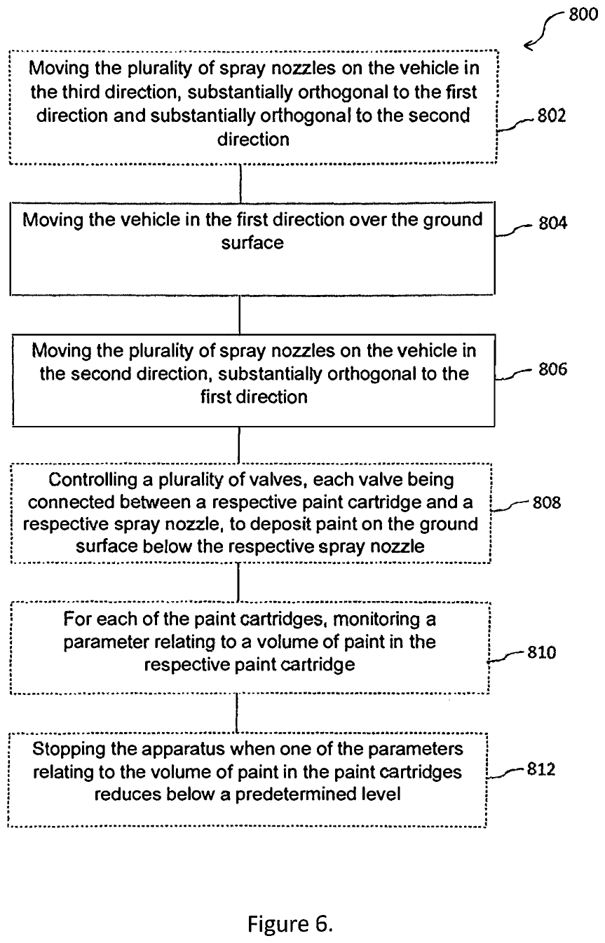

FIG. 6

FIG. 6 illustrates a flow diagram of a method 800 of marking a ground surface 100, the method 800 comprising block 804 where, in use, the ground printer 10 is moved in a first direction 14 over the ground surface 100, and block 806 where, in use, a plurality of spray nozzles 26 on the ground printer 10 are moved in a second direction 20, substantially orthogonal to the first direction 14. In particular, the method 800 of marking a ground surface 100 can be carried out using the ground printer 10 as previously described.

In an initialization phase for the ground printer 10, a number of actions can be carried out to initialize the ground printer 10 for printing an image on a ground surface 100, these actions being dependent on the current status of the ground printer 10. In particular a print task can be provided to the ground printer 10, by the provision of instructions from a remote server being sent to the ground printer via controller 36 on the ground printer 10, those instructions being enacted by an application processor (not shown) connected to the controller 36.

At block 802 the method 800 may comprise: moving the plurality of spray nozzles 26 on the ground printer 10 in the third direction 24, substantially orthogonal to the first direction 14 and substantially orthogonal to the second direction 20. Such movement of the plurality of spray nozzles 26 may be required in order to provide an appropriate pixel size for the image printing or to account for the type of surface forming the ground surface 100.

At block 808, the method 800 may comprise: controlling a plurality of valves (not shown), each valve (not shown) being connected between a respective paint cartridge 30 and a respective spray nozzle 26, to deposit paint on the ground surface 100 below the respective spray nozzle 26.

At block 810, the method 800 may comprise: for each of the paint cartridges 30, monitoring a parameter relating to a volume of paint in the respective paint cartridge 30.

At block 812, the method 800 may comprise stopping the ground printer 10 when one of the parameters relating to the volume of paint in the paint cartridges 30 reduces below a predetermined level. By stopping the ground printer 10, this then allows for the replacement or refilling of the paint cartridge 30 to avoid errors in printing an image through missing areas when paint runs out in a paint cartridge 30. In one embodiment, the ground printer 10 may comprise a weight monitoring device 118 which is in communication with the controller 34 and allows monitoring of the weight of the paint cartridge 30 as the parameter by which the volume of paint in the paint cartridge 30 is ascertained.

Preferably, when the ground printer is in use depositing paint on the ground, the onboard controller 34 is configured to periodically gather weight data from the weight monitoring device 118. The onboard controller 34 is configured to transmit weight data to a remote resource, such as a cloud server, or an edge device optionally a tablet or smartphone, via the communication circuitry 36.

A weight monitoring device 118 and data collection allows the system to alert a user that there is not sufficient paint for deposition for the instructions given to the ground printer 10. For example, prior to operation, the weight monitoring device 118 can check if there is sufficient paint to print an image. The user can be informed prior to carrying out the instructions or task, so that the job is not started.

Although embodiments of the present invention have been described in the preceding paragraphs with reference to various examples, it should be appreciated that modifications to the examples given can be made without departing from the scope of the invention as claimed.

The ground printer 10 and methods 800 described herein can be adapted for use with different types of surface of ground. The ground printer 10 and methods 800 described herein can be used to deposit paint on multiple different substrates, surfaces, or the ground. For example, these could be, grass, turf, AstroTurf, artificial turf, synthetic turf, plastic turf, concrete, polished concrete, tarmac or tarmacadam ground surfaces, dirt, gravel, wood chip, carpeting, rubber, roads, asphalt, brick, sand, beaches, mud, clay wood, decking, tiling, stone, rock and rock formations of varying types of rock or stone, snow, ice, ice rinks, artificial snow, polymer surfaces such as polyurethane, plastic, glass and leather.

The ground printer 10 and methods 800 described herein can be adapted for use with different surfaces, such as sports (e.g. football, cricket, racing, rugby, hockey, ice hockey, skiing, shooting) pitches, ski slopes, dry ski slopes, race courses, gymnasiums, indoor sports venues and running tracks.

In some embodiments, the ground printer 10 and methods 800 described herein may be used for printing or painting on a substrate or on the ground surface 100. This can be to print or paint, with inks or paint, logos, information, advertising or messages on the ground surface 100. When large images are printed, they are printed with adjacent dots or pixels so that when viewed from above or a suitable distance from afar (e.g. from the stand in a stadium or from a television view) the images are easily determined. Print instructions can be determined so that when an image, e.g. a logo is printed, they can be visible from stadium stand or by a viewer watching an event at home on television. The ground printer 10 and methods 800 described herein offer an improvement to printing methods for advertising purposes. Brand logos, slogans, pictures etc. can be printed to advertise a brand, logo or message. These can be printed more efficiently, quickly and with a higher degree of accuracy than the methods and printers of the prior art.

The ground printer 10 is therefore in some embodiments configured to print an image or logo on a ground surface 100, the ground printer housing a plurality of print cartridges containing a material for deposition, the material for deposition contained within each print cartridge being an ink or paint selected from a cyan, magenta, yellow, black, white, green, blue, or red, colour, the image or logo optionally being an advertising logo, design or safety warning. In various embodiments, the material for deposition is a marking material such as a paint, ink, coloured material, or powder.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A ground printer for marking a ground surface, the ground printer comprising a print rack and being configured to travel in a first direction over the ground surface, the print rack comprising:
a horizontal mounting rail positionally fixed to the ground printer and arranged in a second direction, substantially orthogonal to the first direction; and
a vertical mounting rail arranged in a third direction, substantially orthogonal to the first direction and substantially orthogonal to the second direction, the vertical mounting rail being movably connected to the horizontal mounting rail;
wherein a plurality of spray nozzles is mounted to the vertical mounting rail and aligned in a horizontal axis in the first direction.

2. A ground printer according to claim 1, wherein the vertical mounting rail is configured to move along the horizontal mounting rail between a first end stop at a first end of the horizontal mounting rail and a second end stop at a second end of the horizontal mounting rail opposite the first end of the horizontal mounting rail.

3. A ground printer according to claim 2, wherein the first end stop and the second end stop are separated by a distance which is greater than the separation of the wheels of the ground printer.

4. A ground printer according to claim 2, wherein one, or both, of the first end stop and the second end stop comprises a sensor to detect the position of the vertical mounting rail.

5. A ground printer according to claim 1, wherein the vertical mounting rail is configured to move orthogonally to the horizontal mounting rail in the third direction.

6. A ground printer according to claim 2, wherein the horizontal mounting rail comprises a first stepper motor with a first pulley at the first end of the horizontal mounting rail, and a second pulley at the second end of the horizontal mounting rail, the first pulley being operably coupled to the second pulley via a first belt, and a carriage being coupled to the first belt, the carriage being configured to traverse the horizontal mounting rail on operation of the first stepper motor.

7. A ground printer according to claim 6, wherein the first stepper motor comprises a closed loop encoder.

8. A ground printer according to claim 6, wherein the vertical mounting rail comprises a second stepper motor with a third pulley at a first end of the vertical mounting rail, and a fourth pulley at a second end of the vertical mounting rail opposite the first end of the vertical mounting rail, the third pulley being operably coupled to the fourth pulley via a second belt, and the carriage being coupled to the second belt to enable the vertical mounting rail to move in the third direction, orthogonally to the horizontal mounting rail on operation of the second stepper motor.

9. A ground printer according to claim 8, wherein the second stepper motor comprises a closed loop encoder.

10. A ground printer according to claim 8, wherein the second stepper motor is configured to provide greater torque output than the first stepper motor.

11. A ground printer according to claim 6, wherein the carriage comprises:
four wheels on a first side of the carriage, the four wheels on the first side of the carriage comprising two wheels configured to engage a first side of a track portion of the horizontal mounting rail and two wheels configured to engage with a second side of the track portion of the horizontal mounting rail opposite the first side of the track portion of the horizontal mounting rail; and
four wheels on a second side of the carriage opposite the first side of the carriage, the four wheels on the second side of the carriage comprising two wheels configured to engage a first side of a track portion of the vertical mounting rail and two wheels configured to engage with a second side of the track portion of the vertical mounting rail opposite the first side of the track portion of the vertical mounting rail.

12. A ground printer according to claim 11, wherein two of the four wheels on the first side of the carriage are provided with eccentric nuts to enable movement of the two wheels on the first side of the carriage relative to the other two of the wheels of the first side of the carriage during tightening to the eccentric nuts in order to clamp the four wheels of the first side of the carriage onto the track portion of the horizontal mounting rail; and
wherein two of the four wheels on the second side of the carriage are provided with eccentric nuts to enable movement of the two wheels on the second side of the carriage relative to the other two wheels of the second side of the carriage during tightening of the eccentric nuts in order to clamp the four wheels of the second side of the carriage onto the track portion of the vertical mounting rail.

13. A ground printer according to claim 1, wherein the plurality of spray nozzles is configured to move in the third direction to modify the separation of the spray nozzles from the ground surface.

14. A ground printer according to claim 1, wherein each spray nozzle of the plurality of spray nozzles is coupled to a separate respective paint cartridge.

15. A ground printer according to claim 14, wherein each spray nozzle is coupled to the separate respective paint cartridge via flexible tubing to accommodate movement of the spray nozzles relative to the respective paint cartridges.

16. A ground printer according to claim 15, wherein the flexible tubing is retained in a first cable carrier mounted to the vertical mounting rail and a second cable carrier mounted to the horizontal mounting rail, the flexible tubing passing from a respective print spray nozzle, through the first cable carrier and then through the second cable carrier, to the respective paint cartridge.

17. A ground printer according to claim 1, wherein the paint is ejected from each spray nozzle under pressure to form small droplets of paint to uniformly cover the ground surface.

18. A ground printer according to claim 1, the ground printer comprising:
a controller configured to control the position of the ground printer on a ground surface, to control the position of the plurality of spray nozzles on the ground printer, and to control the operation of the plurality of spray nozzles to mark the ground surface.

19. A ground printer according to claim 18, wherein the controller is configured to control a valve for each of the plurality of spray nozzles dependent upon the position of the ground printer on the ground surface.

20. A method of marking a ground surface using the ground printer as claimed in claim 1, the method comprising:
moving the ground printer in the first direction over the ground surface; and
moving the plurality of spray nozzles on the ground printer in the second direction, substantially orthogonal to the first direction.

21. A method according to claim 20, the method comprising:
moving the plurality of spray nozzles on the ground printer in the third direction, substantially orthogonal to the first direction and substantially orthogonal to the second direction.

22. A method according to claim 20, the method comprising:
controlling a plurality of valves, each valve being connected between a respective paint cartridge and a respective spray nozzle, to deposit paint on the ground surface below the respective spray nozzle.

23. A method according to claim 22, the method comprising:
for each of the paint cartridges, monitoring a parameter relating to a volume of paint in the respective paint cartridge; and
stopping the ground printer when one of the parameters relating to the volume of paint in the paint cartridges reduces below a predetermined level.
